(19) United States
(12) Patent Application Publication
(10) Pub. No.: US 2026/0278931 A1
(43) Pub. Date: Sep. 17, 2026

(54) MAP DISPLAY METHOD AND APPARATUS, ELECTRONIC DEVICE, AND STORAGE MEDIUM

(71) Applicant: Tencent Technology (Shenzhen) Company Limited, Shenzhen (CN)

(72) Inventors: Zhang CHEN, Shenzhen (CN); Shengjun LIAO, Shenzhen (CN); Bo TANG, Shenzhen (CN)

(73) Assignee: Tencent Technology (Shenzhen) Company Limited, Shenzhen (CN)

(21) Appl. No.: 19/670,418

(22) Filed: May 7, 2026

Related U.S. Application Data
(63) Continuation of application No. PCT/CN2025/081590, filed on Mar. 10, 2025.

(30) Foreign Application Priority Data
Apr. 9, 2024 (CN) 202410424332.6

(51) Int. Cl. G06T 17/05; G06T 15/50; G06T 19/00; G06T 19/20

(52) U.S. Cl. CPC G06T 17/05; G06T 15/50; G06T 19/003; G06T 19/20

(57) ABSTRACT

A map display method, apparatus, and computer-readable storage medium for enhanced three-dimensional map visualization through dynamic opacity control. The method displays a three-dimensional map screen from a virtual observation point, showing stereoscopic landscape models at varying distances. Models are categorized by distance intervals, with closer models in a first interval and farther models in a second interval. Upon virtual observation point position changes, the map screen is redrawn by adjusting model opacities based on distance: closer model opacity increases with distance (positive correlation), while farther model opacity decreases with distance (negative correlation). This distance-based opacity adjustment creates depth perception and visual clarity by emphasizing relevant landscape features relative to the observer's position.

### CROSS-REFERENCE TO RELATED APPLICATIONS

This application is a continuation application of International Application No. PCT/CN2025/081590 filed on March 10, 2025 which claims priority to Chinese Patent Application No. 202410424332.6, filed with the China National Intellectual Property Administration on April 9, 2024, the disclosures of each being incorporated by reference herein in their entireties.

### FIELD

The disclosure relates to the field of computers, a map display method and apparatus, an electronic device, and a storage medium.

### BACKGROUND

A three-dimensional map technology is a technology in which ground geographic features are presented in a stereoscopic form by using a geographic information system (GIS), computer graphics, and map manufacturing technologies. Usually, in the three-dimensional map technology, various landscape models such as buildings, trees, and vehicles are loaded into a landform by using satellite remote sensing data, and a realistic three-dimensional map is generated in combination with technologies such as rendering and texturing in the computer graphics. The three-dimensional map technology can be used in various application fields such as traffic navigation, city planning, and resource management.

However, a manner in the related art for displaying a three-dimensional map is simple, and a user observes a landscape in the three-dimensional map by dragging and zooming the three-dimensional map. As a virtual observation point moves, a problem that a display effect is poor usually occurs due to excessive high buildings, for example, high buildings nearby occlude the virtual observation point of a user, or dense high buildings far away have poor visual appearance.

### SUMMARY

Provided are a map display method and apparatus, a device, a storage medium, and a program product, which can implement enhanced three-dimensional map visualization through distance-based opacity adjustment of landscape models relative to virtual observation points.

According to some embodiments, a map display method, performed by an electronic device, includes: displaying a three-dimensional map screen observed at a virtual observation point of a three-dimensional map, the three-dimensional map comprising stereoscopic landscape models, the landscape models including: a first model at a first distance from the virtual observation point, the first distance being within a first interval; and a second model at a second distance from the virtual observation point, the second distance being within a second interval, wherein a largest value of the first interval is less than a smallest value of the second interval; wherein the three-dimensional map screen includes a first model image of the first model and a second model image of the second model; and based on a position change operation on the virtual observation point, redrawing the three-dimensional map screen by modifying an opacity of the first model and an opacity of the second model such that: an opacity of the first model image is positively correlated with the first distance; and an opacity of the second model image is negatively correlated with the second distance.

According to some embodiments, a map display apparatus, includes: at least one memory configured to store program code; and at least one processor configured to read the program code and operate as instructed by the program code, the program code including: display code configured to cause at least one of the at least one processor to display a three-dimensional map screen observed at a virtual observation point of a three-dimensional map, the three-dimensional map comprising stereoscopic landscape models, the landscape models including: a first model at a first distance from the virtual observation point, the first distance being within a first interval; and a second model at a second distance from the virtual observation point, the second distance being within a second interval, wherein a largest value of the first interval is less than a smallest value of the second interval; wherein the three-dimensional map screen includes a first model image of the first model and a second model image of the second model; and redrawing code configured to cause at least one of the at least one processor to redraw, based on a position change operation on the virtual observation point, the three-dimensional map screen by modifying an opacity of the first model and an opacity of the second model such that: an opacity of the first model image is positively correlated with the first distance; and an opacity of the second model image is negatively correlated with the second distance.

According to some embodiments, a non-transitory computer-readable storage medium, storing computer code which, when executed by at least one processor, causes the at least one processor to at least: display a three-dimensional map screen observed at a virtual observation point of a three-dimensional map, the three-dimensional map comprising stereoscopic landscape models, the landscape models including: a first model at a first distance from the virtual observation point, the first distance being within a first interval; and a second model at a second distance from the virtual observation point, the second distance being within a second interval, wherein a largest value of the first interval is less than a smallest value of the second interval; wherein the three-dimensional map screen includes a first model image of the first model and a second model image of the second model; and redraw, based on a position change operation on the virtual observation point, the three-dimensional map screen by modifying an opacity of the first model and an opacity of the second model such that: an opacity of the first model image is positively correlated with the first distance; and an opacity of the second model image is negatively correlated with the second distance.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an effect of a map display method according to some embodiments.

FIG. 2 is a schematic diagram of an effect of a map display method according to some embodiments.

FIG. 3 is a schematic flowchart of a map display method according to some embodiments.

FIG. 4 is a schematic diagram of a range of a map display method according to some embodiments.

FIG. 5 is a schematic flowchart of drawing applied in a map display method according to some embodiments.

FIG. 6 is a schematic diagram of an interaction operation of a rendering thread applied to a map display method according to some embodiments.

FIG. 7 is a schematic diagram of a structure of a map display apparatus according to some embodiments.

FIG. 8 is a schematic diagram of a structure of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related "some embodiments" describe a subset of all possible embodiments. However, it may be understood that the "some embodiments" may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The following will clearly and completely describe technical solutions in embodiments of this application with reference to the accompanying drawings in the embodiments of this application. Clearly, described embodiments are merely a part of the embodiments of this application, rather than all of the embodiments. All other embodiments obtained by a person of ordinary skill in the art based on the embodiments of this application without creative efforts shall fall within the protection scope of this application.

The embodiments of this application provide a map display method and apparatus, an electronic device, and a storage medium.

The map display apparatus may be integrated into the electronic device, and the electronic device may be a device such as a terminal or a server. The terminal may be a device such as a mobile phone, an in-vehicle terminal, an intelligent appliance, an intelligent voice interaction device, a tablet computer, an intelligent Bluetooth device, a notebook computer, or a personal computer (PC). The server may be a single server, or may be a server cluster including a plurality of servers.

In some embodiments, the map display apparatus may further be integrated into a plurality of electronic devices. For example, the map display apparatus may be integrated into the plurality of servers, and the plurality of servers implement the map display method in this application.

In some embodiments, the server may alternatively be implemented in a terminal form.

For example, the electronic device may be the terminal. The terminal may display a three-dimensional map screen of a three-dimensional map observed at a virtual observation point, the three-dimensional map including stereoscopic landscape models, the landscape models including a first model at a first distance from the virtual observation point and a second model at a second distance from the virtual observation point, the first distance being within a first interval, the second distance being within a second interval, a largest value of the first interval being less than a smallest value of the second interval, and the three-dimensional map screen including a first model image of the first model and a second model image of the second model; and redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in a redrawn three-dimensional map screen.

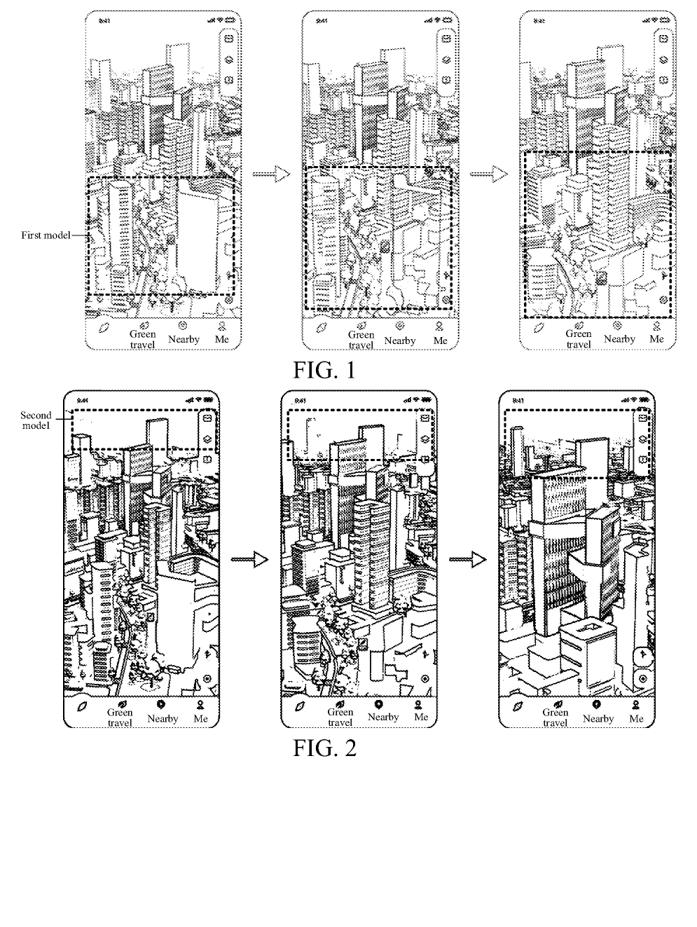

For example, the electronic device may be a mobile phone, and the mobile phone may be provided with a map client. With reference to FIG. 1, the map client may display the three-dimensional map screen, the three-dimensional map screen includes a screen of the three-dimensional map observed at the virtual observation point, and the three-dimensional map includes buildings presented in a stereoscopic form. In response to a zoom-in operation on the virtual observation point, the first model in the buildings changes from solid to virtual until transparent. With reference to FIG. 2, the second model in the building gradually becomes solid from transparent to virtual in response to the zoom-in operation on the virtual observation point.

Detailed descriptions are respectively provided below. The serial numbers of the following embodiments are not intended to limit a preferred sequence of the embodiments.

An intelligent traffic system (ITS), also referred to as an intelligent transportation system, effectively and comprehensively applies advanced science and technologies (an information technology, a computer technology, a data communication technology, a sensor technology, an electronic control technology, an automatic control theory, an operational research, artificial intelligence, and the like) to traffic and transportation, service control, and vehicle manufacture, and enhances associations between vehicles, roads, and users, to form a comprehensive transportation system that ensures security, improves efficiency, improves an environment, and saves energy.

An electronic map is an important part of the intelligent traffic system and is a map existing in a digital form. The electronic map stores and processes geographical information in a form of electronic data, and may be displayed and used on devices such as a computer, a smart phone, and a tablet computer. Through features such as digitalization, interactivity, and real-time performance, the electronic maps provide convenient and quick geographical information display and application services for users, and are widely applied to various fields such as navigation, tourism, and geographical information analysis.

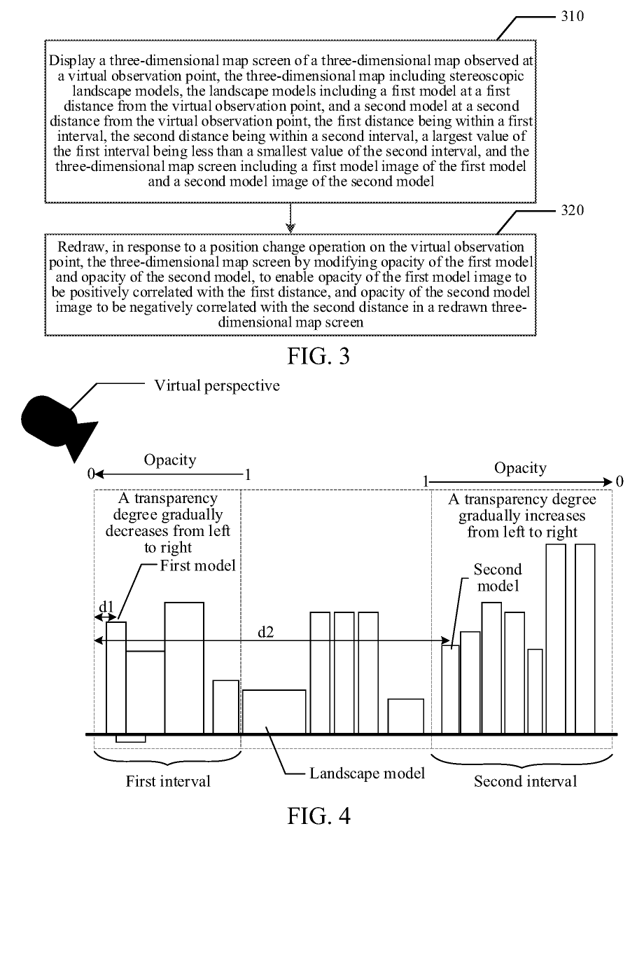

In some embodiments, a map display method related to an electronic map is provided. As shown in FIG. 3, a procedure of the map display method may be as follows:

310: Display a three-dimensional map screen of a three-dimensional map observed at a virtual observation point, the three-dimensional map including stereoscopic landscape models, the landscape models including a first model at a first distance from the virtual observation point, and a second model at a second distance from the virtual observation point, the first distance being within a first interval, the second distance being within a second interval, a largest value of the first interval being less than a smallest value of the second interval, and the three-dimensional map screen including a first model image of the first model and a second model image of the second model.

A virtual perspective is a virtual perspective simulated by using a computer technology, so that a user can observe and interact in a virtual environment. In some embodiments, the user can control the virtual perspective to freely observe the three-dimensional map through operations such as moving, zooming out, zooming in, and rotating. The virtual observation point is a position at which the virtual perspective is located, and the position may be represented as a point in the three-dimensional map.

The first interval refers to a distance range interval. A landscape model corresponding to a distance value within the interval is defined as the first model, and a largest value of the first interval is less than a smallest value of the second interval. A value of the interval may be determined based on an actual application scenario. For example, the first interval may range from 0 meters to A meters, or may range from 0 meters to 15 meters in some embodiments.

The second interval refers to a distance range interval. A landscape model corresponding to a distance value within the interval is defined as the second model, and the smallest value of the second interval is greater than the largest value of the first interval. A value of the interval may be determined based on an actual application scenario. For example, the second interval may range from B meters to infinity, or may range from 200 meters to 400 meters in some embodiments.

The landscape models may include landscape models located on the ground, such as a building model, a plant model, a vehicle model, and a traffic sign model. In some embodiments, in addition to the foregoing landscape models, the three-dimensional map may further include ground models. The ground models may include object models located on a ground surface, such as a road network model, a water body model, or a terrain feature model, and further include an area model such as a park and a plaza.

In some embodiments, to reduce consumption of calculation resources and ensure display smoothness, only models near the virtual observation point can be loaded, to reduce calculation of a system and network transmission load, and ensure that the user always sees objects near the virtual observation point. Therefore, operation 310 includes the following operations: obtaining candidate models and determining positions of the candidate models in the three-dimensional map; determining candidate models whose positions are within a loading range of the virtual observation point as the landscape models; loading the landscape models in the three-dimensional map; and drawing the three-dimensional map, to obtain and display the three-dimensional map screen.

The candidate models and the positions of the candidate models may be obtained from a database or an internal memory.

The loading range may be set as required. In some embodiments, the candidate models may be determined by using a frustum culling technology, a dynamic loading technology, a level of detail (LOD) technology, a pre-loading technology, occlusion culling, or the like.

The frustum culling is an optimization technology that calculates a view frustum of the virtual observation point to cull models located outside the view frustum, and loads only models inside the view frustum. In this way, it can be ensured that only models near an area currently observed by the user are loaded, thereby improving rendering efficiency.

The dynamic loading technology is a technology that dynamically loads models near the virtual observation point when the virtual observation point is moved or changed. By detecting movement and a change of the virtual observation point, the system can load or unload the models near the virtual observation point in real time, to keep the user always seeing latest scenery, and avoid loading of an unnecessary model. By detecting movement and a change of the virtual observation point, the system can load or unload the models near the virtual observation point in real time, to keep the user seeing latest scenery all the time, and avoid loading an unnecessary model.

The level of detail technology reduces a rendering load by using models of different levels at different distances. For example, a high-resolution model may be loaded in an area near the virtual observation point, and a low-resolution model may be loaded in an area far away from the virtual observation point, to maintain a balance between performance and quality.

The pre-loading technology refers to a technology that pre-loads the models near the virtual observation point before the user moves. Through pre-loading, user waiting duration can be reduced, thereby improving user experience. During the pre-loading, possibly required models may be loaded in advance based on a current position and moving direction of the user.

The occlusion culling technology determines, based on an occlusion relationship between objects, objects that are invisible during rendering, and directly culls invisible models.

Through the foregoing optimization policy, the performance and the user experience of the three-dimensional map can be effectively improved, so that the user can smoothly browse and interact in the virtual environment.

320: Redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in a redrawn three-dimensional map screen.

The position change operation is an operation configured for changing a position of the virtual observation point in the three-dimensional map, and mainly includes a zoom-in operation and a zoom-out operation. When the position change operation occurs, the three-dimensional map screen may be redrawn by modifying the opacity of the first model and the opacity of the second model.

In some embodiments, to further reduce the consumption of the calculation resources and improve smoothness, all the first models and the second models in the screen may be controlled to simultaneously play a preset transparency change animation. For example, all first models in a screen may be loaded and simultaneously play a preset first transparency change animation, and all the second models in the screen may be loaded and simultaneously play a second transparency change animation. animation parameters of the first transparency change animation and the second transparency change animation may be set as required.

The transparency change animation refers to an animation configured for controlling a change of opacity of the landscape models. The opacity of the landscape models may be changed based on a preset rule by loading and playing the animation.

The first transparency change animation refers to a preset animation configured for controlling a change of the opacity of the first model, and may be, for example, that the opacity linearly changes from 1 to 0 within preset duration. The second transparency change animation refers to a preset animation configured for controlling a change of opacity of the second model, and may be, for example, that the opacity linearly changes from 0 to 1 within preset duration.

Opacity being 1 indicates being completely opaque, and opacity being 0 indicates being completely transparent.

In some embodiments, to make a visual effect more accurate and detailed, distances between each first model, each second model, and the virtual observation point in the screen may alternatively be controlled to fine-tune opacity of each first model and each second model.

For example, with reference to FIG. 4, in operation 320, the opacity of the first model may be positively correlated with a first distance d1, and the opacity of the second model may be negatively correlated with a second distance d2. To be specific, for the first model, a smaller first distance d1 indicates a more transparent first model. For the second model, a larger second distance d2 indicates a more transparent second model.

In some embodiments, the distance may refer to a linear distance, and the linear distance refers to a shortest distance between two points. In some embodiments, the distance may refer to a horizontal distance, and the horizontal distance refers to a component of the linear distance along a horizontal plane.

For example, the distance may refer to the horizontal distance. The landscape models include the first model at the first distance from the virtual observation point and the second model at the second distance from the virtual observation point. The first distance is within the first interval, the second distance is within the second interval, and the largest value of the first interval is less than the smallest value of the second interval. The first distance d1 is a distance between the first model and the virtual observation point, and the second distance d2 is a distance between the second model and the virtual observation point.

A complementary set between the first interval and the second interval may be denoted as a middle interval, and a landscape model located in the middle interval may be denoted as a middle model. In some embodiments, opacity of the intermediate model may be 1.

In some embodiments, values of the first interval and the second interval may be determined based on an actual application scenario. For example, in some embodiments, a smallest value of the first interval may be 0, and a largest value of the second interval may be infinity. For example, in some embodiments, the first interval ranges from 0 to A meters, the middle interval ranges from A meters to B meters, and the second interval ranges from B meters to infinity.

In some embodiments, a third interval may further exist. The third interval refers to a distance range interval whose smallest value is greater than the largest value of the second interval. For example, in some embodiments, the first interval ranges from 0 meters to A meters, the middle interval ranges from A meters to B meters, the second interval ranges from B meters to C meters, and the third interval ranges from C meters to infinity.

In some embodiments, a landscape model located in the third interval may be denoted as a third model. In some embodiments, opacity of the third model may be 0. In some embodiments, to further reduce the consumption of the calculation resource, no landscape model may be loaded within the third interval of the three-dimensional map.

In some embodiments, a transparency channel may be added to textures of the landscape model, so that transparency of the landscape model is controlled by adjusting a texture parameter of the model.

For example, the landscape model may use textures in an RGBA format, and an A channel indicates transparency. A value of the transparency channel is controlled based on a horizontal distance between the landscape model and the virtual observation point, and after adjustment is completed, the three-dimensional map screen is redrawn based on adjusted textures of the landscape model. The textures in the RGBA format refer to a color encoding manner configured for representing an image or model textures. R indicates red, G indicates green, and B indicates blue. The three channels jointly determine a hue of a color. A indicates a transparency (Alpha) channel, configured for controlling a transparency degree of a texture part. In this application, the landscape model may use the textures in the RGBA format, and the transparency of the landscape model is controlled by adjusting a value of the A channel.

Therefore, in some embodiments, before the three-dimensional map screen is redrawn by modifying the opacity of the first model and the opacity of the second model, the method may further include: determining distances between the landscape models and the virtual observation point; determining a landscape model whose distance is within the first interval as the first model; and determining a landscape model whose distance is within the second interval as the second model.

In some embodiments, the position change operation may include the zoom-in operation. The redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in a redrawn three-dimensional map screen may include the following operations: increasing the opacity of the second model and decreasing the opacity of the first model in response to the zoom-in operation on the virtual observation point; and redrawing the three-dimensional map screen based on the opacity of the first model and the opacity of the second model.

For example, in response to the zoom-in operation on the virtual observation point, the opacity of the second model is increased and the opacity of the first model is decreased by playing a preset transparency animation.

For example, in response to the zoom-in operation on the virtual observation point, the opacity of the first model is decreased by calculating a decrease amount based on the first distance, and the opacity of the second model is increased by calculating an increase amount based on the second distance.

Similarly, in some embodiments, the position change operation may include the zoom-out operation. The redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in a redrawn three-dimensional map screen may include the following operations: decreasing the opacity of the second model and increasing the opacity of the first model in response to the zoom-out operation on the virtual observation point; and redrawing the three-dimensional map screen based on the opacity of the first model and the opacity of the second model.

For example, in response to the zoom-out operation on the virtual observation point, the opacity of the second model is decreased and the opacity of the first model is increased by playing a preset transparency animation.

For example, in response to the zoom-out operation on the virtual observation point, the opacity of the first model is increased by calculating an increase amount based on the first distance, and the opacity of the second model is decreased by calculating a decrease amount based on the second distance.

When the opacity of the models is fine-tuned based on the first distance and the second distance, in some embodiments, when the first distance is equal to the smallest value of the first interval, the opacity of the first model is set to 0, and when the first distance is equal to the largest value of the first interval, the opacity of the first model is set to 1. In some embodiments, when the second distance is equal to the smallest value of the second interval, the opacity of the second model is set to 1, and when the second distance is equal to the largest value of the second interval, the opacity of the second model is set to 0. When the opacity is already 0, the opacity is no longer decreased. When the opacity is already 1, the opacity is no longer increased.

In some embodiments, the three-dimensional map may further include ground models. To improve drawing efficiency and ensure a correct occlusion relationship between the landscape models, the redraw the three-dimensional map screen by modifying opacity of the first model and opacity of the second model, to enable opacity of the first model image to be positively correlated with the first distance, and opacity of the second model image to be negatively correlated with the second distance in a redrawn three-dimensional map screen may include the following operations: drawing the ground models; a determining a drawing sequence of the landscape models based on depth information of the landscape models after drawing of the ground models is completed; and drawing the landscape models based on the drawing sequence.

Elements located in the foreground and elements located in the background in an image are determined based on the depth information, to generate an image having a depth sense. In some embodiments, depth information of pixels of the landscape models may be stored by using a depth buffer or a Z-buffer. Before the pixels are colored, depth testing may be performed based on the depth information, to determine pixels to be drawn in the foreground and pixels to be occluded. The depth testing is a testing operation of determining, before the pixels are colored and based on the depth information of the pixels of the landscape models that is stored in the depth buffer or the Z-buffer, the pixels to be drawn in the foreground and the pixels to be occluded.

In some embodiments, to further improve the drawing efficiency and reduce the consumption of the calculation resource, the first models, the second models, and other landscape models may be drawn in batches. Therefore, the drawing the landscape models based on the drawing sequence may include the following operations: drawing the second models based on a drawing sequence of the second models; drawing the other models based on a drawing sequence of the other models after drawing of the second models is completed, the other models being landscape models other than the first models and the second models; and drawing the first models based on a drawing sequence of the first models after drawing of the other models is completed.

In some embodiments, to further optimize a rendering process and reduce the consumption of the calculation resource, models to be drawn may be determined in the landscape models by using a frustum culling technology, a dynamic loading technology, a level of detail technology, and a pre-loading technology, to cull landscape models that do not affect a display effect. Therefore, the determining a drawing sequence of the landscape models based on depth information of the landscape models may include the following operations: determining, based on a preset screening rule, the models to be drawn in the landscape models; and determining, based on depth information of the models to be drawn, a drawing sequence of the models to be drawn. The drawing the landscape models based on the drawing sequence may include the following operation: drawing, based on the drawing sequence, the models to be drawn.

The screening rule is a rule configured for determining the models to be drawn in the landscape models, and may be determined by using a frustum culling technology, an occlusion culling technology, or the like. The models to be drawn refer to models that are determined from the landscape models based on the preset screening rule and that may be drawn, for example, landscape models within a view of the virtual observation point, or unoccluded landscape models screened for based on an occlusion relationship.

For example, in some embodiments, the frustum culling technology is used, and the determining, based on a preset screening rule, models to be drawn in the landscape models may include the following operations: determining the models to be drawn in the landscape models, the models to be drawn being the landscape models within the view of the virtual observation point; and determining, based on the depth information of the models to be drawn, the drawing sequence of the models to be drawn.

For example, in some embodiments, the occlusion culling technology is used, and the determining, based on a preset screening rule, models to be drawn in the landscape models may include the following operations: determining, based on the depth information of the landscape models, an occlusion relationship between the models to be drawn; and screening for, based on the occlusion relationship, the models to be drawn from the landscape models.

In the embodiments of this application, the three-dimensional map screen of the three-dimensional map observed at the virtual observation point may be displayed, the three-dimensional map including the stereoscopic landscape models, the landscape models including the first model at the first distance from the virtual observation point and the second model at the second distance from the virtual observation point, the first distance being within the first interval, the second distance being within the second interval, the largest value of the first interval being less than the smallest value of the second interval, and the three-dimensional map screen including the first model image of the first model and the second model image of the second model; and the three-dimensional map screen is redrawn, in response to the position change operation on the virtual observation point, by modifying the opacity of the first model and the opacity of the second model, to enable the opacity of the first model image to be positively correlated with the first distance, the opacity of the second model image to be negatively correlated with the second distance, the opacity of the first model to be positively correlated with the first distance, and the opacity of the second model to be negatively correlated with the second distance in the redrawn three-dimensional map screen. In the map screen provided in the embodiments of this application, for a landscape located nearby, that is, the first models, the first models are more transparent when the first models are closer to the virtual observation point, and the first models are clearer when the first models are farther from the virtual observation point. For a landscape located far away, that is, the second models, the second models are clearer when the second models are closer to the virtual observation point, and the second models are more transparent when the second models are farther from the virtual observation point. Therefore, closer high buildings have lower opacity, so that the user is not occluded from observing other buildings. Buildings farther away have higher opacity, so that visual appearance that the buildings farther away are excessively dense can be weakened. Therefore, this solution can improve an image effect of the displayed three-dimensional map screen.

Further descriptions are provided in detail below according to the method described in the foregoing embodiments.

First, a disappearance animation is preset, and the disappearance animation can gradually reduce the opacity from 1 to 0 within one second. An appearance animation is preset, and the appearance animation can gradually increase the opacity from 0 to 1 within one second.

The appearance animation is a preset animation that can gradually increase the opacity from 0 to 1 within a time period, configured for achieving a visual effect that the landscape models transition from virtual to real until completely displayed. The disappearance animation is a preset animation that can gradually reduce the opacity from 1 to 0 within a time period, configured for achieving a visual effect that the landscape models transition from real to virtual until it disappears.

With reference to FIG. 1, when the observation point zooms in, buildings nearby are loaded and the disappearance animation is played, to achieve a visual effect that the buildings transition from real to virtual until they disappear, and buildings far away are loaded and the appearance animation is played, to achieve a visual effect that the buildings transition from virtual to real until completely displayed. when the observation point zooms out, the buildings nearby are loaded and the appearance animation is played, to achieve the visual effect that the buildings transition from virtual to real until completely displayed, and the buildings far away are loaded and the disappearance animation is played, to achieve the visual effect that the buildings transition from real to virtual until they disappear.

A value of opacity set for the animation may be randomly set based on an actual requirement.

In some embodiments, a solution in which a transparent animation is played by using a building model is used as an example, to describe the method of the embodiments of this application in detail.

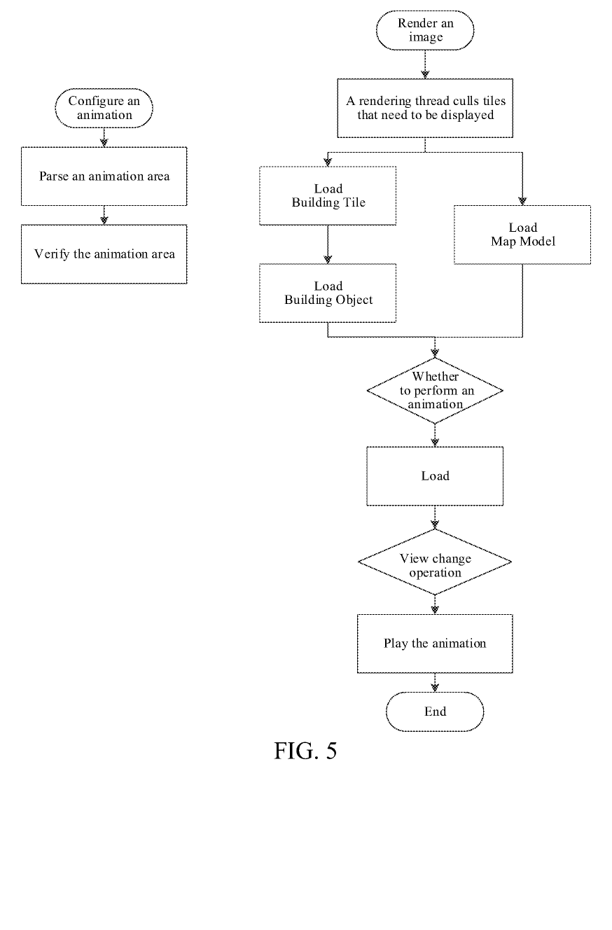

As shown in FIG. 5, a procedure of a map display method is as follows:

201: Configure an animation.

1. Parse an animation area. The animation area may include a first area and a second area. The first area is an area within a first interval from a virtual observation point, and the second area is an area within a second interval from the virtual observation point. The animation area refers to an area within a interval from the virtual observation point, and landscape models within the area are configured with animations and play the animations.

The first area is a part of the animation area, and is the area within the first interval from the virtual observation point. Landscape models within this area are determined as first models, and appearance and disappearance animations corresponding to the first models are loaded. The second area is a part of the animation area, and is the area within the second interval from the virtual observation point. Landscape models within this area are determined as second models, and appearance and disappearance animations corresponding to the second models are loaded.

In some embodiments, the first interval may range from 0 meters to 15 meters, and the second interval may range from 200 meters to 400 meters.

2. Check the first area and the second area.

202: Render an image.

1. A rendering thread culls building tiles to be displayed.

A tile refers to a small element configured for constructing a model.

In some embodiments, the rendering thread may determine a view of the virtual observation point based on a position, an orientation, and a parameter of the virtual observation point; determine building tiles located within the view of the virtual observation point; and in some embodiments, the rendering thread may further cull invisible building tiles to reduce unnecessary rendering operations.

When a building is loaded, a building tile, a building object, and additionally, a three-dimensional map map model may also be loaded.

The building tile is a type of tile, and is a small element configured for constructing a building model. The tile is loaded when the building is loaded. The building object refers to a model object representing the building, which is loaded when the building is loaded. A resource thread determines a building model that can be drawn therefrom based on an LOD technology. The map model refers to a model of a three-dimensional map.

2. Determine whether to perform an animation for the building, if so, load the animation for the building.

A landscape model whose distance is within the first interval is determined as the first model; and a landscape model whose distance is within the second interval is determined as the second model. For the first model, the appearance and disappearance animations corresponding to the first model may be loaded, and for the second model, the appearance and disappearance animations corresponding to the second model may be loaded.

3. In response to a position change operation on the virtual observation point, play the animation.

For example, in response to a zoom-in operation, the first model plays a disappearance animation, and the second model plays an appearance animation.

For example, in response to a zoom-out operation, the second model plays a disappearance animation, and the first model plays an appearance animation.

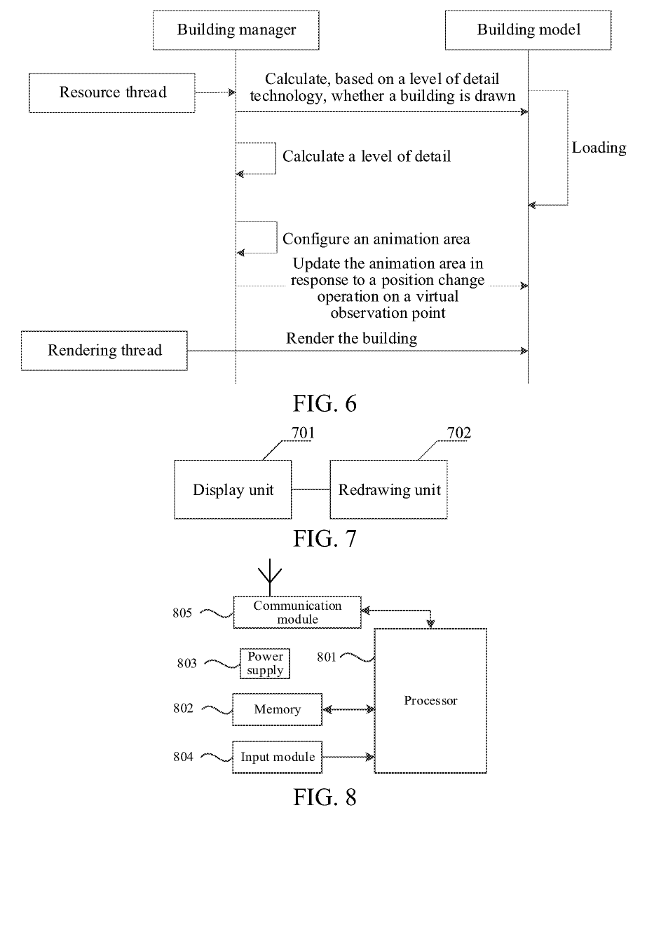

FIG. 6 is an interaction operation of a rendering thread. A building Manager may manage and configure a model parameter of a building, and a building object is a building model. The building manager may manage and configure the model parameter of the building, and play a role in an interaction process of the thread rendering.

A resource thread is configured for determining, based on an LOD technology, a building model that can be drawn in the building object, loading the model into a three-dimensional map, and then determining an animation area based on the LOD technology to perform animation configuration on buildings in the animation area; and updating, in response to a position change operation on a virtual observation point, a screen to play an animation.

The rendering thread is configured for rendering the building, and includes rendering textures of the building, such as transparency.

Through some embodiments, a problem of view occlusion by high buildings and a problem of large performance consumption due to a large quantity of building blocks far away can be resolved. In addition, a use of fade-in and fade-out animation effects standardizes a manner of block appearance and disappearance, and reasonably reduces a coverage area of the building blocks far away, thereby reducing the performance consumption and alleviating a problem of view occlusion by high building nearby.

An image effect of the displayed three-dimensional map screen can be improved according to some embodiments of this application.

In a implementation of this application, relevant data such as topographic data and navigation data is related. When the following embodiments of this application are applied to a product or technology, permission or consent may be obtained, and collection, use, and processing of the relevant data may comply with relevant laws and regulations, and standards of relevant countries and regions.

To better implement the foregoing method, some embodiments further provides a map display apparatus. The map display apparatus may be integrated into an electronic device, and the electronic device may be a device such as a terminal or a server. The terminal may be a device such as a mobile phone, a tablet computer, a smart Bluetooth device, a laptop computer, or a personal computer. The server may be a single server or a server cluster including a plurality of servers.

For example, in some embodiments, an example in which the map display apparatus is integrated into the terminal is configured for describing the method of embodiments of this application in detail.

For example, as shown in FIG. 7, the map display apparatus may include a display unit 701 and a redrawing unit 702, as follows:

(1) The display unit 701 is configured to display a three-dimensional map screen.

A three-dimensional map includes stereoscopic landscape models, the landscape models include a first model at a first distance from a virtual observation point, and a second model at a second distance from the virtual observation point, the first distance is within a first interval, the second distance is within a second interval, a largest value of the first interval is less than a smallest value of the second interval, and the three-dimensional map screen includes a first model image of the first model and a second model image of the second model.

In some embodiments, the display unit 701 is configured to: obtain candidate models, and determine positions of the candidate models in the three-dimensional map; determine candidate models whose positions are within a loading range of the virtual observation point as landscape models; load the landscape models in the three-dimensional map; and draw the three-dimensional map, to obtain and display the three-dimensional map screen.

(2) The redrawing unit 702 is configured to redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in a redrawn three-dimensional map screen.

In some embodiments, before redrawing a three-dimensional map screen by modifying opacity of the first model and opacity of the second model, the redrawing unit 702 is further configured to: determine a distance between the landscape model and the virtual observation point; determine a landscape model whose distance is within the first interval as the first model; and determine a landscape model whose distance is within the second interval as the second model.

In some embodiments, the position change operation includes a zoom-in operation, and the redrawing unit 702 is configured to: increase the opacity of the second model and decrease the opacity of the first model in response to the zoom-in operation on the virtual observation point; and redraw the three-dimensional map screen based on the opacity of the first model and the opacity of the second model.

In some embodiments, the position change operation includes a zoom-out operation, and the redrawing unit 702 is configured to: decrease the opacity of the second model and increase the opacity of the first model in response to the zoom-out operation on the virtual observation point; and redraw the three-dimensional map screen based on the opacity of the first model and the opacity of the second model.

In some embodiments, when the first distance is equal to a smallest value of the first interval, the opacity of the first model is set to 0; and when the first distance is equal to the largest value of the first interval, the opacity of the first model is set to 1.

In some embodiments, when the second distance is equal to the smallest value of the second interval, the opacity of the second model is set to 1; and when the second distance is equal to a largest value of the second interval, the opacity of the second model is set to 0.

In some embodiments, the three-dimensional map further includes ground models, and the redrawing unit 702 is configured to: draw the ground models; determine a drawing sequence of the landscape models based on depth information of the landscape models after drawing of the ground models is completed; and draw the landscape models based on the drawing sequence.

In some embodiments, that draw the landscape models based on the drawing sequence includes: draw the second models based on a drawing sequence of the second models; draw other models based on a drawing sequence of the other models after drawing of the second models is completed, the other models being landscape models other than the first models and the second models; and draw the first models based on a drawing sequence of the first models after drawing of the other models is completed.

In some embodiments, that determine a drawing sequence of the landscape models based on depth information of the landscape models includes: determine, based on a preset screening rule, models to be drawn in the landscape models; and determine a drawing sequence of the models to be drawn based on depth information of the models to be drawn. That draw the landscape models based on the drawing sequence includes: draw the models to be drawn based on the drawing sequence.

In some embodiments, that determine, based on a preset screening rule, models to be drawn in the landscape models includes: determine the models to be drawn in the landscape models, the models to be drawn being the landscape models within a view of the virtual observation point; and determine, based on the depth information of the models to be drawn, the drawing sequence of the models to be drawn.

In some embodiments, that determine models to be drawn in the landscape models based on a preset screening rule includes: determine, based on the depth information of the landscape models, an occlusion relationship between the models to be drawn; and screen for, based on the occlusion relationship, the models to be drawn from the landscape models.

In a implementation, each of the foregoing units may be implemented as an independent entity, or may be combined arbitrarily, or may be implemented as the same entity or several entities. For implementation of each of the foregoing units, refer to the foregoing method embodiments, and details are not described herein again.

In some embodiments of this application, the term "module" or "unit" refers to a computer program or a part of a computer program having a predetermined function, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The map display apparatus of some embodiments displays the three-dimensional map screen of the three-dimensional map observed at the virtual observation point by the display unit, the three-dimensional map including stereoscopic landscape models, the landscape models including the first model at the first distance from the virtual observation point and the second model at the second distance from the virtual observation point, the first distance being within the first interval, the second distance being within the second interval, the largest value of the first interval being less than the smallest value of the second interval, and the three-dimensional map screen including the first model image of the first model and the second model image of the second model; and the redrawing unit, in response to the position change operation on the virtual observation point, redraws the three-dimensional map screen by modifying the opacity of the first model and the opacity of the second model, to enable the opacity of the first model image to be positively correlated with the first distance, and the opacity of the second model image to be negatively correlated with the second distance in the redrawn three-dimensional map screen.

Therefore, a map display effect can be improved according to some embodiments of this application.

Some embodiments further provides an electronic device. The electronic device may be a device such as a terminal or a server. The terminal may be a mobile phone, a tablet computer, a smart Bluetooth device, a notebook computer, a personal computer, or the like. The server may be a single server, a server cluster including a plurality of servers, or the like.

In some embodiments, the map display apparatus may further be integrated into a plurality of electronic devices. For example, the map display apparatus may be integrated into the plurality of servers, and the plurality of servers implement the map display method in this application.

In some embodiments, an example in which the electronic device in some embodiments is the terminal is configured for detailed description. For example, FIG. 8 is a schematic diagram of a structure of an electronic device related to some embodiments of this application, specifically:

The electronic device may include components such as a processor 801 including one or more processing cores, a memory 802 including one or more computer-readable storage media, a power supply 803, an input module 804, and a communication module 805. A person skilled in the art may understand that the structure of the electronic device shown in FIG. 8 does not constitute a limitation to the electronic device, and the electronic device may include more components or fewer components than those shown in the figure, or some components may be combined, or a different component deployment may be used. The processor 801 is a control center of the electronic device, and is connected to various parts of the entire electronic device by using various interfaces and lines. By running or executing the software program and/or module stored in the memory 802, and invoking data stored in the memory 802, the processor 801 performs various functions and data processing of the electronic device, thereby performing overall detection on the electronic device.

In some embodiments, the processor 801 may include one or more processing cores. In some embodiments, the processor 801 may integrate an application processor and a modem processor. The application processor mainly processes an operating system, a user interface, an application program, and the like. The modem mainly processes wireless communication. The foregoing modem processor may either not be integrated into the processor 801.

The memory 802 may be configured to store a software program and a module. The processor 801 executes various function applications and data processing by running the software program and the module stored in the memory 802. The memory 802 may mainly include a program storage area and a data storage area. The program storage area may store an operating system, an application program required by at least one function (such as a sound play function and an image play function), and the like. The data storage area may store data created based on a use of the electronic device, and the like. In addition, the memory 802 may include a high-speed random access memory, and may also include a non-volatile memory such as at least one magnetic disk storage device, a flash memory, or another volatile solid-state storage device. Correspondingly, the memory 802 may further include a memory controller, to provide access to the memory 802 for the processor 801.

The electronic device further includes the power supply 803 for supplying power to the components. In some embodiments, the power supply 803 may be logically connected to the processor 801 by using a power management system, thereby implementing functions such as charging, discharging, and power consumption management by using the power management system. The power supply 803 may further include any component such as one or more direct current or alternating current power supplies, a recharging system, a power failure detection circuit, a power supply converter or inverter, a power supply state indicator.

The electronic device may further include the input module 804. The input module 804 may be configured to receive inputted digit or character information, and generate a keyboard, mouse, joystick, optical, or track ball signal inputs related to a user setting and function control.

The electronic device may further include the communication module 805. In some embodiments, the communication module 805 may include a wireless module. The electronic device may perform short-distance wireless transmission by using the wireless module of the communication module 805, to provide wireless broadband Internet access for a user. For example, the communication module 805 may be configured to help the user receive and send e-mails, browse a web page, access streaming media, and so on.

Although not shown in the figure, the electronic device may further include a display unit and the like, and details are not described herein again. Specifically, in some embodiments, the processor 801 of the electronic device loads executable files corresponding to processes of one or more application programs into the memory 802 based on the following instructions, and runs the application programs stored in the memory 802, to implement various functions as follows: display a three-dimensional map screen of a three-dimensional map observed at a virtual observation point, the three-dimensional map including stereoscopic landscape models, the landscape models including a first model at a first distance from the virtual observation point and a second model at a second distance from the virtual observation point, the first distance being within a first interval, the second distance being within a second interval, a largest value of the first interval being less than a smallest value of the second interval, and the three-dimensional map screen including a first model image of the first model and a second model image of the second model; and redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in the redrawn three-dimensional map screen.

For implementations of each of the foregoing operations, refer to the foregoing embodiments, and details are not described herein again.

A map display effect can be improved according to some embodiments of this application.

A person of ordinary skill in the art may understand that all or some of the operations of the various methods in the foregoing embodiments may be completed by instructions, or by controlling relevant hardware through instructions, and the instructions may be stored in a computer-readable storage medium and loaded and executed by the processor.

In view of this, some embodiments provides a computer-readable storage medium, having a plurality of instructions stored therein. The instructions can be loaded by a processor to perform operations in any map display method provided in the embodiments of this application. For example, the instructions may perform the following operations: display a three-dimensional map screen of a three-dimensional map observed at a virtual observation point, the three-dimensional map including stereoscopic landscape models, the landscape models including a first model at a first distance from the virtual observation point and a second model at a second distance from the virtual observation point, the first distance being within a first interval, the second distance being within a second interval, a largest value of the first interval being less than a smallest value of the second interval, and the three-dimensional map screen including a first model image of the first model and a second model image of the second model; and redraw, in response to a position change operation on the virtual observation point, the three-dimensional map screen by modifying opacity of the first model and opacity of the second model, to enable opacity of the first model image to be positively correlated with the first distance, and opacity of the second model image to be negatively correlated with the second distance in the redrawn three-dimensional map screen.

The storage medium may include: a read only memory (ROM), a random access memory (RAM), a magnetic disk, an optical disc, or the like.

According to an aspect of this application, a computer program product or a computer program is provided. The computer program product or the computer program includes computer instructions, and the computer instructions are stored in the computer-readable storage medium. The processor of an electronic device reads the computer instructions from the computer-readable storage medium, and executes the computer instructions, so that the electronic device performs the methods provided in various exemplary implementations of the map display aspects provided in the foregoing embodiments.

Because the instructions stored in the storage medium may perform operations in any map display method provided in the embodiments of this application, beneficial effects achievable by any map display method provided in the embodiments of this application can be achieved. For details, refer to the foregoing embodiments, and details are not described herein again.

The map display method and apparatus, the electronic device, the storage medium, and the computer program product provided in this application first display the three-dimensional map screen of the three-dimensional map observed at the virtual observation point, the three-dimensional map including the stereoscopic landscape models. The three-dimensional landscape models include the first model and the second model that are located at different interval distances from the virtual observation point, the largest value of the first interval is less than the smallest value of the second interval, and the screen includes images corresponding to the two models. Subsequently, when the position change operation on the virtual observation point is performed, the electronic device redraws the three-dimensional map screen by modifying the opacity of the first model and the opacity of the second model, to enable the opacity of the first model image to be positively correlated with the first distance, and the opacity of the second model image to be negatively correlated with the second distance in the redrawn screen. In this way, a problem that a display effect of the three-dimensional map is poor due to excessive high buildings can be improved. Transparency of high buildings nearby increases as the buildings approach the virtual observation point, so that the user is not occlude from observing other buildings. Opacity of high buildings far away decreases as the buildings move away from the virtual observation point, which weakens visual appearance that the building far away are excessively dense, thereby improves a display effect of the three-dimensional map screen.

Further, before the three-dimensional map screen is displayed, the distance between the landscape model and the virtual observation point is first determined, then a landscape model whose distance is within the first interval is determined as the first model, and a landscape model whose distance is within the second interval is determined as the second model. This operation clarifies a manner of determining the first model and the second model, which helps subsequently precisely adjust the opacity based on the distance between the model and the virtual observation point, thereby further improving accuracy of the display effect of the three-dimensional map screen.

When the position change operation is the zoom-in operation, the electronic device increases the opacity of the second model and decreases the opacity of the first model in response to the operation, and then redraws the three-dimensional map screen based on the adjusted opacity. Such processing for the zoom-in operation conforms to a logic that the first models are more transparent when the first models are closer to the virtual observation point and the second models are clearer when the second models are closer to the virtual observation point, so that a visual effect when the user zooms in for observation is optimized, to avoid occlusion of the high building nearby and enhance a display effect of the high buildings far away.

When the position change operation is the zoom-out operation, the electronic device reduces the opacity of the second model and increases the opacity of the first model in response to the operation, and then redraws the three-dimensional map screen based on the adjusted opacity. This conforms to a logic that the first models are clearer when the first models are farther from the virtual observation point, and the second models are more transparent when the second models are farther from the virtual observation point, so that a visual effect when the user zooms out for observation, to enable a screen display to more conform to an observation requirement of the user.

When the first distance equals the smallest value of the first interval, the opacity of the first model is set to 0, and when the first distance equals the largest value of the first interval, the opacity of the first model is set to 1. This clarifies opacity setting of the first model at a distance, so that a positive correlation between the opacity of the first model and the distance is more specific, and a display effect of the first model at different distances is further accurately optimized, thereby improving the accuracy of the screen display.

When the second distance equals the smallest value of the second interval, the opacity of the second model is set to 1, and when the second distance equals the largest value of the second interval, the opacity of the second model is set to 0. This clarifies opacity setting of the second model at a distance, so that a negative correlation between the opacity of the second model and the distance is more specific, and a display effect of the second model at different distances is further accurately optimized, thereby improving the accuracy of the screen display.

If the three-dimensional map further includes the ground models, when the three-dimensional map screen is redrawn by modifying the opacity of the first model and the opacity of the second model, the ground models are drawn first, after the drawing is completed, the drawing sequence of the landscape models is determined based on the depth information of the landscape models, and finally, the landscape models are drawn based on the sequence. This ensures reasonableness of a sequence of the ground models and the landscape model and the drawing sequence of the landscape models. In combination with the depth information, the occlusion relationship between the landscape models can be correctly presented, thereby improving drawing efficiency and sense of reality of the screen display.

When the landscape models are drawn based on the drawing sequence, the second models are first drawn based on the second model drawing sequence. After the drawing of the second model is completed, the other landscape models other than the first models and the second models are drawn based on the drawing sequence of the other models. Finally, the first models are drawn based on the drawing sequence of the first models. This batch drawing manner further improves the drawing efficiency, optimizes a landscape model drawing procedure, and helps improve a display effect of an overall screen.

When the drawing sequence of the landscape models is determined based on the depth information of the landscape models, the models to be drawn are first determined in the landscape models based on the preset screening rule, then the drawing sequence of the models to be drawn is determined based on the depth information of the models to be drawn, and finally, the models to be drawn are drawn based on the sequence. In this process, the models to be drawn are screened out, and the landscape models that do not affect the display effect are culled, thereby further optimizing a rendering process, reducing the consumption of the calculation resource, and improving the drawing efficiency and the display effect of the screen.

When the models to be drawn are determined based on the preset screening rule, the landscape models within the view of the virtual observation point are determined as the models to be drawn, and then the drawing sequence is determined based on the depth information of the models to be drawn. In this way, it is ensured that only models within the view of the user are drawn, thereby improving the rendering efficiency, avoiding unnecessary calculation resource waste, and improving the display effect of the screen.

When the models to be drawn are determined based on the preset screening rule, the occlusion relationship between the models to be drawn is first determined based on the depth information of the landscape models, and then the models to be drawn are screened for from the landscape models based on the occlusion relationship. Such a manner of screening out the models to be drawn based on the occlusion relationship may further optimize rendering, avoid drawing occluded models, reduce the consumption of the calculation resource, and improve the display effect of the screen.

When the three-dimensional map screen is displayed, the candidate models are first obtained and the positions of the candidate models in the three-dimensional map are determined, the candidate models located in the loading range of the virtual observation point are determined as the landscape models, and after the landscape models are loaded in the three-dimensional map, the three-dimensional map is drawn, to obtain and display the three-dimensional map screen. In this process, the models near the virtual observation point are only loaded, and system calculation and network transmission load are reduced, so that the display smoothness is ensured, thereby improving the user experience.

In addition, all the first models and the second models in the screen may be controlled to simultaneously play the preset transparency change animation, to further reduce the consumption of the calculation resource and improve the smoothness. The transparency is controlled by adding the transparency channel to the textures of the landscape model. There is the middle interval and the third interval. Solutions such as different opacity or loading policies are set for models located in different intervals, and the map display method is optimized from different aspects, thereby jointly improving the display effect of the three-dimensional map, and resolving the problem of view occlusion by the high buildings and the problem of the large performance consumption due to a large quantity of the building blocks far away.

Technical features of the foregoing embodiments may be combined in different manners to form other embodiments. For brevity of description, not all possible combinations of the technical features in the foregoing embodiments are described. However, as long as combinations of the technical features do not contradict each other, it is to be considered that the combinations of the technical features fall within the scope of this specification.

The foregoing embodiments only describe several implementations of this application, which are described and in detail, and therefore cannot be construed as a limitation to the scope of the invention patent. A person of ordinary skill in the art may further make various changes and improvements without departing from the idea of this application, and these changes and improvements all fall within the protection scope of this application. Therefore, the protection scope of the patent of this application shall be subject to the appended claims.

What is claimed is:

1. A map display method, performed by an electronic device, the method comprising:
displaying a three-dimensional map screen observed at a virtual observation point of a three-dimensional map, the three-dimensional map comprising stereoscopic landscape models, the landscape models including:
a first model at a first distance from the virtual observation point, the first distance being within a first interval; and
a second model at a second distance from the virtual observation point, the second distance being within a second interval, wherein a largest value of the first interval is less than a smallest value of the second interval;
wherein the three-dimensional map screen includes a first model image of the first model and a second model image of the second model; and
based on a position change operation on the virtual observation point, redrawing the three-dimensional map screen by modifying an opacity of the first model and an opacity of the second model such that:
an opacity of the first model image is positively correlated with the first distance; and
an opacity of the second model image is negatively correlated with the second distance.

2. The map display method according to claim 1, further comprising:
determining a respective distance between each of the landscape models and the virtual observation point;
determining, as the first model, a landscape model whose respective distance is within the first interval; and
determining, as the second model, a landscape model whose respective distance is within the second interval.

3. The map display method according to claim 1, wherein the position change operation comprises a zoom-in operation, and wherein the redrawing comprises:
based on the zoom-in operation, increasing the opacity of the second model and decreasing the opacity of the first model; and
redrawing the three-dimensional map screen based on decreased the opacity of the first model and the increased opacity of the second model.

4. The map display method according to claim 1, wherein the position change operation comprises a zoom-out operation, and wherein the redrawing comprises:
based on the zoom-out operation, decreasing the opacity of the second model and increasing the opacity of the first model; and redrawing the three-dimensional map screen based on the increased opacity of the first model and the decreased opacity of the second model.

5. The map display method according to claim 3, wherein, based on the first distance being equal to the smallest value of the first interval, the opacity of the first model is set to 0; and based on the first distance being equal to the largest value of the first interval, the opacity of the first model is set to 1.

6. The map display method according to claim 4, wherein, based on the second distance being equal to the smallest value of the second interval, the opacity of the second model is set to 1; and based on the second distance being equal to the largest value of the second interval, the opacity of the second model is set to 0.

7. The map display method according to claim 4, wherein the three-dimensional map further comprises ground models, and wherein the redrawing comprises:
drawing the ground models;
determining a drawing sequence of the landscape models based on depth information of the landscape models; and
drawing the landscape models based on the drawing sequence.

8. The map display method according to claim 7, wherein the drawing the landscape models comprises:
drawing the second models based on a drawing sequence of the second models;
drawing other models based on a drawing sequence of the other models, the other models being landscape models other than the first models and the second models; and
drawing the first models based on a drawing sequence of the first models.

9. The map display method according to claim 7, wherein the determining the drawing sequence comprises:
determining, based on a preset screening rule, models to be drawn from among the landscape models; and
determining, based on depth information of the models to be drawn, a drawing sequence of the models to be drawn; and
the drawing the landscape models comprises:
drawing the models to be drawn based on the drawing sequence.

10. The map display method according to claim 9, wherein the determining the models to be drawn comprises:
determining, as the models to be drawn, landscape models within a view of the virtual observation point; and
determining, based on the depth information of the models to be drawn, the drawing sequence of the models to be drawn.

11. The map display method according to claim 9, wherein the determining the models to be drawn comprises:
determining, based on the depth information of the landscape models, an occlusion relationship between the models to be drawn; and
selecting, based on the occlusion relationship, the models to be drawn from the landscape models.

12. The map display method according to claim 1, wherein the displaying comprises:
obtaining candidate models, and determining positions of the candidate models in the three-dimensional map;
determining, as the landscape models, candidate models whose positions are within a loading range of the virtual observation point;
loading the landscape models into the three-dimensional map; and
drawing the three-dimensional map to obtain the three-dimensional map screen.

13. A map display apparatus, comprising:
at least one memory configured to store program code; and
at least one processor configured to read the program code and operate as instructed by the program code, the program code comprising:
display code configured to cause at least one of the at least one processor to display a three-dimensional map screen observed at a virtual observation point of a three-dimensional map, the three-dimensional map comprising stereoscopic landscape models, the landscape models including:
a first model at a first distance from the virtual observation point, the first distance being within a first interval; and
a second model at a second distance from the virtual observation point, the second distance being within a second interval, wherein a largest value of the first interval is less than a smallest value of the second interval;
wherein the three-dimensional map screen includes a first model image of the first model and a second model image of the second model; and
redrawing code configured to cause at least one of the at least one processor to redraw, based on a position change operation on the virtual observation point, the three-dimensional map screen by modifying an opacity of the first model and an opacity of the second model such that:
an opacity of the first model image is positively correlated with the first distance; and
an opacity of the second model image is negatively correlated with the second distance.

14. The apparatus according to claim 13, wherein the program code further comprises:
determination code configured to cause at least one of the at least one processor to determine a respective distance between each of the landscape models and the virtual observation point;
first code configured to cause at least one of the at least one processor to determine, as the first model, a landscape model whose respective distance is within the first interval; and
second code configured to cause at least one of the at least one processor to determine, as the second model, a landscape model whose respective distance is within the second interval.

15. The apparatus according to claim 13, wherein the position change operation comprises a zoom-in operation, and wherein the redrawing code is further configured to cause at least one of the at least one processor to:
based on the zoom-in operation, increase the opacity of the second model and decrease the opacity of the first model; and
redraw the three-dimensional map screen based on decreased the opacity of the first model and the increased opacity of the second model.

16. The apparatus according to claim 13, wherein the position change operation comprises a zoom-out operation, and wherein the redrawing code is further configured to cause at least one of the at least one processor to:
based on the zoom-out operation, decrease the opacity of the second model and increase the opacity of the first model; and
redraw the three-dimensional map screen based on the increased opacity of the first model and the decreased opacity of the second model.

17. The apparatus according to claim 15, wherein, based on the first distance being equal to the smallest value of the first interval, the opacity of the first model is set to 0; and based on the first distance being equal to the largest value of the first interval, the opacity of the first model is set to 1.

18. The apparatus according to claim 16, wherein, based on the second distance being equal to the smallest value of the second interval, the opacity of the second model is set to 1; and based on the second distance being equal to the largest value of the second interval, the opacity of the second model is set to 0.

19. The apparatus according to claim 16, wherein the three-dimensional map further comprises ground models, and wherein the redrawing code is further configured to cause at least one of the at least one processor to:
draw the ground models;
determine a drawing sequence of the landscape models based on depth information of the landscape models; and
draw the landscape models based on the drawing sequence.

20. A non-transitory computer-readable storage medium, storing computer code which, when executed by at least one processor, causes the at least one processor to at least:
display a three-dimensional map screen observed at a virtual observation point of a three-dimensional map, the three-dimensional map comprising stereoscopic landscape models, the landscape models including:
a first model at a first distance from the virtual observation point, the first distance being within a first interval; and
a second model at a second distance from the virtual observation point, the second distance being within a second interval, wherein a largest value of the first interval is less than a smallest value of the second interval;
wherein the three-dimensional map screen includes a first model image of the first model and a second model image of the second model; and
based on a position change operation on the virtual observation point, redraw the three-dimensional map screen by modifying an opacity of the first model and an opacity of the second model such that:
an opacity of the first model image is positively correlated with the first distance; and
an opacity of the second model image is negatively correlated with the second distance.
